(19) United States
(12) Patent Application Publication
(10) Pub. No.: US 2018/0298499 A1
(43) Pub. Date: Oct. 18, 2018

(54) Anodized Layer and Aluminum Layer over Substrate

(71) Applicant: HEWLETT-PACKARD DEVELOPMENT COMPANY, L.P., HOUSTON, TX (US)

(72) Inventors: CHI HAO CHANG, TAIPEI CITY (TW); CHALAM KASHYAP, FORT COLLINS, CO (US); KUAN-TING WU, TAIPEI CITY (TW)

(21) Appl. No.: 15/519,697

(22) PCT Filed: Apr. 30, 2015
(86) PCT No.: PCT/US2015/028643

§ 371 Date: Apr. 17, 2017

(51) Int. Cl. C23C 28/02; B32B 15/01; C23C 24/10; C25D 11/04; C23F 17/00

(52) U.S. Cl. CPC C23C 28/023; B32B 15/017; C23F 17/00; C25D 11/04; C23C 24/106

(57) ABSTRACT

Various examples described herein provide for a substrate, or a method for preparing a substrate, including an aluminum layer and an anodized layer over a substrate. For instance, the substrate may comprise a substrate, a continuous aluminum layer formed over the substrate, and an anodized layer formed over the continuous aluminum layer.

### BACKGROUND

Various electronic products, such as laptops, tablets, media players, and smartphones, and the like, have a set of external surfaces having a metallic finish. In addition to providing aesthetic appeal, a metallic-finish surface can strengthen the housing of the electronic products.

### BRIEF DESCRIPTION OF THE DRAWINGS

Certain examples are described in the following detailed description in reference to the following drawings.

FIGS. 1-4 illustrate example methods or forming a substrate according to the present disclosure.

FIGS. 5 and 6 illustrate example substrates according to the present disclosure.

### DETAILED DESCRIPTION

Various examples described herein provide for substrates or methods for preparing substrates that include an aluminum layer and an anodized layer over a non-metal substrate. Substrates described herein may be utilized as part of an electronic device, such as a laptop, tablet, media player, or a cellular telephone. The substrates may be part of a housing of an electronic device, which may support or house a number of components of the electronic device.

According to some examples, an aluminum powder coating is applied to a non-metal substrate, a laser (e.g., laser treatment) is applied to the aluminum powder coating, and a top layer of the laser-treated aluminum powder coating is anodized. According to various examples, a plastic film containing aluminum filler is applied to a non-metal substrate, a laser (e.g., laser treatment) is applied to the plastic film, and a top layer of the laser-treated plastic film is anodized. For various examples, the light reflected by applying a laser to an aluminum powder coating or a plastic film containing aluminum filler, as described herein, is less in comparison to applying a direct laser beam on an aluminum surface, which has more luster than the former. The reduction in light reflection indicates that more laser energy can be absorbed by the aluminum powder coating or the plastic film containing aluminum filler than by an aluminum surface. Depending on the example, the resulting substrate may possess an anodized cosmetic surface feature and may possess a surface having a distinctive metallic feel. Some examples provide for a non-aluminum substrate with an anodized surface.

As used herein, the terms “over,” “under,” “between,” and “on” refer to a relative position of one layer with respect to other layers. As such, for example, one layer formed over or under another layer may be directly in contact with the other layer or may have a set of intervening layers. Moreover, one layer disposed between two layers may be directly in contact with the two layers or may have a set of intervening layers. In contrast, a first layer “on” a second layer is in contact with that second layer. Additionally, the relative position of one layer with respect to other layers is provided assuming operations are performed relative to a substrate without consideration of the absolute orientation of the substrate.

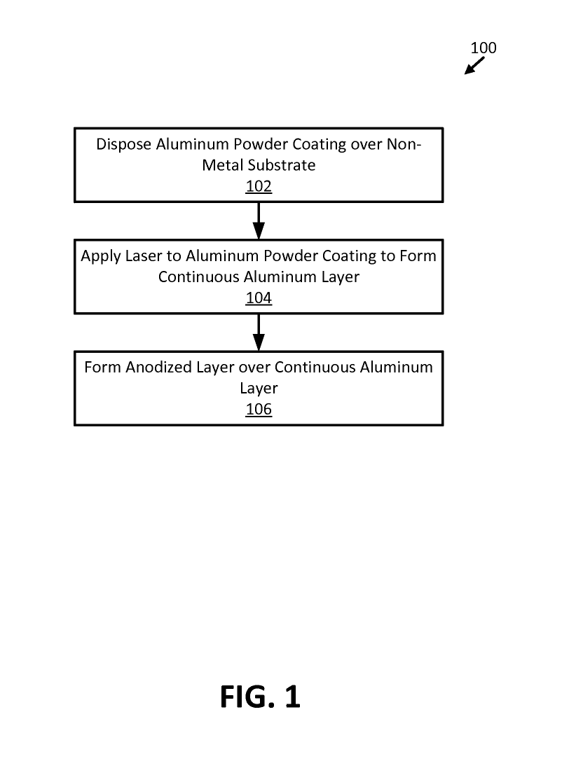

FIG. 1 illustrates an example method 100 for forming a substrate according to the present disclosure. The method 100 may be implemented in the form of executable instructions stored on a non-transitory computer-readable medium or implemented in the form of electronic circuitry, which may cause a set of machines to prepare a substrate according to example described herein. The sequence of operations described in connection with FIG. 1 is not intended to be limiting, and an implementation consistent with the example of FIG. 1 need not perform the sequence of operations in the particular order depicted.

As shown, the method 100 begins at block 102 by disposing an aluminum powder coating (e.g., isolated aluminum powder) over a non-metal substrate. The aluminum powder coating may comprise a thermoplastic resin, such as polyacetale, polyacrylnitrile, polyethylene, polymethylmetacrylate, polypropylene, polystyrene, polyvinylacetate, polyvinylchloride, flcopolymer, chlorinated polyethers, linear polyurethane, polyamide, polycarbonate, polyester, polyimide and polysulphone. Depending on the example, the non-metal substrate may comprise a polymer, a ceramic, or a composite (e.g., carbon fibers).

For alternative examples, the non-aluminum substrate is utilized in place of the non-metal substrate. The non-aluminum substrate may include a non-aluminum metal, such as magnesium, lithium, zinc, titanium, or niobium, or may include a non-aluminum alloy. As described herein, the aluminum powder coating may be disposed on the non-metal substrate such that the aluminum powder coating is in contact with the non-metal substrate. The aluminum powder coat may comprise a polymeric resin containing aluminum or aluminum alloy particles, which may be sprayed onto the non-metal substrate as an aluminum liquid paint.

The method 100 continues to block 104 by applying a laser (e.g., laser treatment) to the aluminum powder coating, disposed over the non-metal substrate at block 102, to form a continuous aluminum layer over the non-metal substrate. In particular, applying the laser to the aluminum powder coating may cause the aluminum powder coating to melt and form a continuous aluminum layer over the non-metal substrate. Additionally, for some examples, applying the laser to the aluminum powder coating may cause organic resin present in the non-metal substrate to be removed. As described herein, the continuous aluminum layer formed may be disposed on and in contact with the non-metal substrate (e.g., where the aluminum powder is disposed on the non-metal substrate at block 102).

The method 100 continues to block 106 by forming an anodized layer over the continuous aluminum layer that was formed at block 104. For some examples, the anodize layer is formed by anodizing the top layer of the continuous aluminum layer formed at block 104. As described herein, the anodized layer may be disposed on and in contact with the continuous aluminum layer formed at block 104.

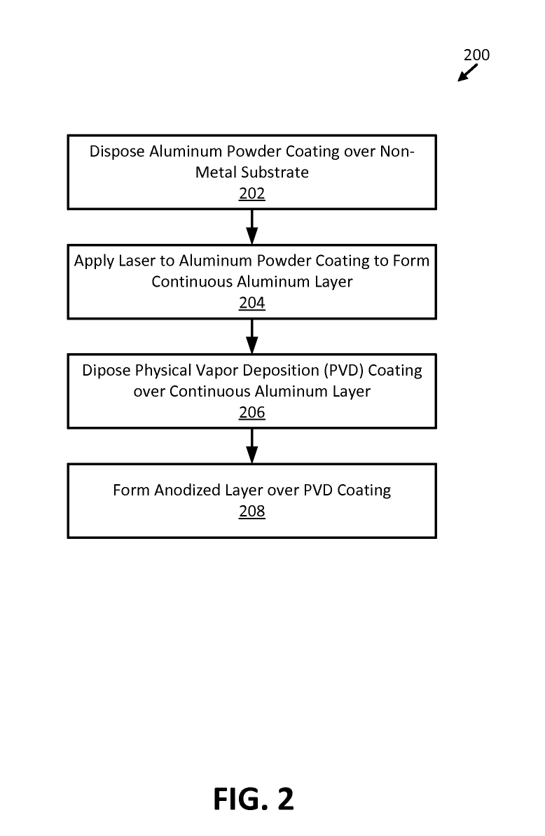

FIG. 2 illustrates an example method 200 for forming a substrate according to the present disclosure. The method 200 may be implemented in the form of executable instructions stored on a non-transitory computer-readable medium or implemented in the form of electronic circuitry, which may cause a set of machines to prepare a substrate according to example described herein. The sequence of operations described in connection with FIG. 2 is not intended to be limiting, and an implementation consistent with the example of FIG. 2 need not perform the sequence of operations in the particular order depicted.

As shown, the method 200 begins at block 202 and continues to block 204, where blocks 202 and 204 may be respectively similar to blocks 102 and 104 of the method 100 described with respect to FIG. 1.

The method 200 continues to block 206 by disposing a physical vapor deposition (PVD) coating over the continuous aluminum layer that was formed at block 204. Depending on the example, disposing the PVD coating over the continuous aluminum layer may comprise performing physical vapor deposition by ion-beam sputtering (IBS), reactive sputtering, ion-assisted deposition (IAD), high-target-utilization sputtering, high-power impulse magnetron sputtering (HIPIMS), gas flow sputtering, chemical vapor deposition, or the like. The PVD coating may comprise aluminum or an aluminum alloy. As described herein, the PVD coating may be disposed on and in contact with the continuous aluminum layer formed at block 204.

The method 200 continues to block 208 by forming an anodized layer over the PVD coating that was disposed at block 206. For some examples, the anodize layer is formed by anodizing the top layer of the PVD coating disposed at block 206. As described herein, the anodized layer may be disposed on and in contact with the PVD coating disposed at block 206.

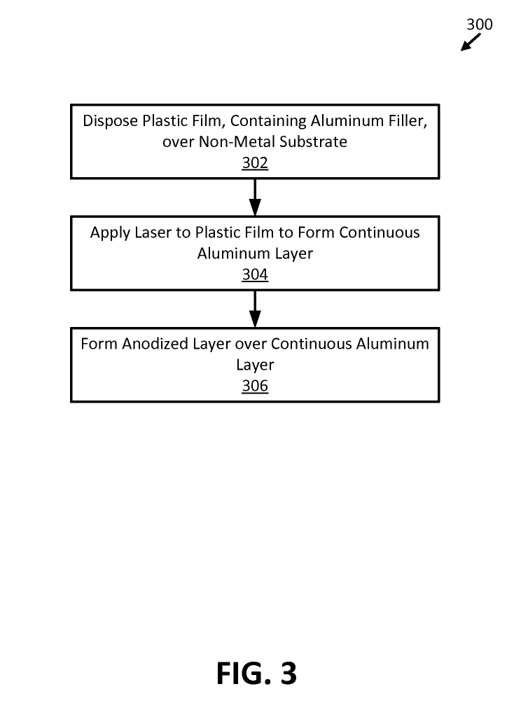

FIG. 3 illustrates an example method 300 for forming a substrate according to the present disclosure. The method 300 may be implemented in the form of executable instructions stored on a non-transitory computer-readable medium or implemented in the form of electronic circuitry, which may cause a set of machines to prepare a substrate according to example described herein. The sequence of operations described in connection with FIG. 3 is not intended to be limiting, and an implementation consistent with the example of FIG. 3 need not perform the sequence of operations in the particular order depicted.

As shown, the method 300 begins at block 302 by disposing a plastic film, containing aluminum filler, over a non-metal substrate. Disposing the plastic film over the non-metal substrate may comprise insert molding the plastic film over the non-metal substrate. Depending on the example, the plastic film may include an in-mold decoration (IMD), an outside mold decoration (OMD), an in-mold film (IMF), an in-mold label (IML) or an outside mold release-film (OMR). As described herein, the plastic film may be disposed on the non-metal substrate such that the plastic film is in contact with the non-metal substrate.

The method 300 continues to block 304 by applying a laser to the plastic film, disposed over the non-metal substrate at block 302, to form a continuous aluminum layer over the non-metal substrate. In some examples, applying the laser to the plastic film may cause the aluminum powder coating to melt and form a continuous aluminum layer over the non-metal substrate. Further, applying the laser to the plastic film may cause organic resin present in the non-metal substrate or the resin of the plastic film to be removed. As described herein, the continuous aluminum layer formed may be disposed on and in contact with the non-metal substrate (e.g., where the plastic is disposed on the non-metal substrate at block 102).

The method 300 continues to block 306 by forming an anodized layer over the continuous aluminum form that was formed at block 304. For some examples, the anodized layer is formed by anodizing the top layer of the continuous aluminum layer formed at block 304. As described herein, the anodized layer may be disposed on and in contact with the continuous aluminum layer formed at block 304.

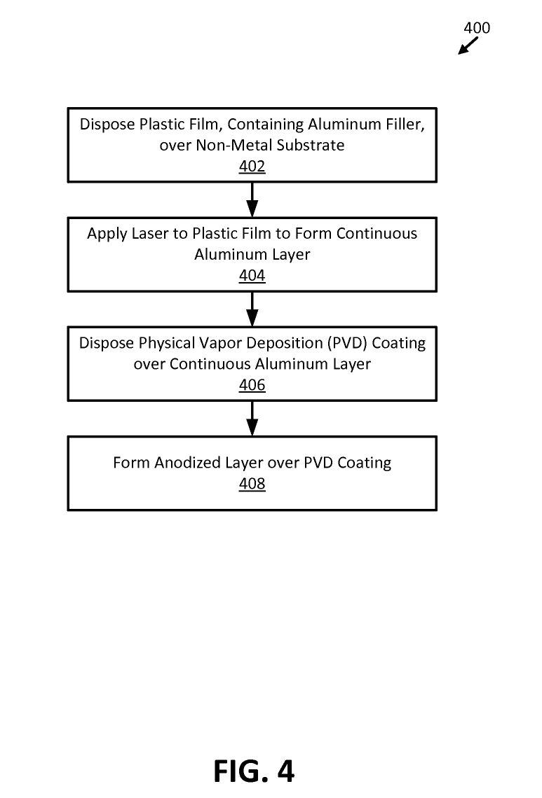

FIG. 4 illustrates an example method 400 for forming a substrate according to the present disclosure. The method 400 may be implemented in the form of executable instructions stored on a non-transitory computer readable medium or implemented in the form of electronic circuitry, which may cause a set of machines to prepare a substrate according to example described herein. The sequence of operations described in connection with FIG. 4 is not intended td be limiting, and an implementation consistent with the example of FIG. 4 need not perform the sequence of operations in the particular order depicted.

As shown, the method 400 begins at block 402 and continues to block 404, where blocks 402 and 404 may be respectively similar to blocks 302 and 304 of the method 300 described with respect to FIG. 3.

The method 400 continues to block 406 by disposing a physical vapor deposition (PVD) coating over the continuous aluminum layer that was formed at block 404. As described herein, disposing the PVD coating over the continuous aluminum layer may comprise performing physical vapor deposition by ion-beam sputtering (IBS), reactive sputtering, ion-assisted deposition (IAD), high-target-utilization sputtering, high-power impulse magnetron sputtering (HIPIMS), gas flow sputtering, chemical vapor deposition, or the like. As also described herein, the PVD coating may comprise aluminum or an aluminum alloy. The PVD coating may be disposed on and in contact with the continuous aluminum layer formed at block 404.

The method 400 continues to block 408 by forming an anodized layer over the PVD coating that was disposed at block 406. For some examples, the anodize layer is formed by anodizing the top layer of the PVD coating disposed at block 406. As described herein, the anodized layer may be disposed on and in contact with the PVD coating disposed at block 406.

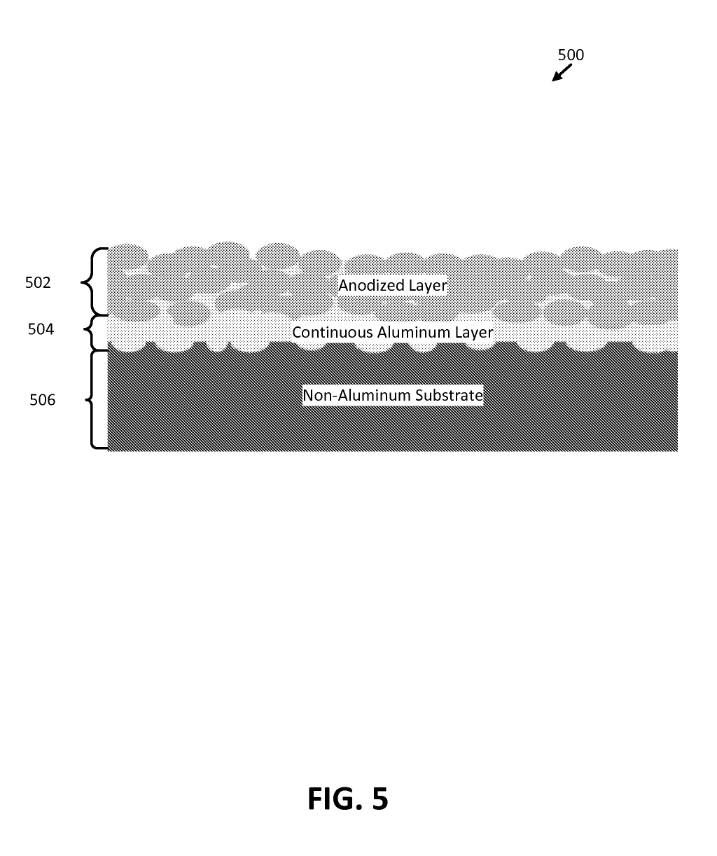

FIG. 5 illustrates an example substrate 500 according to the present disclosure. As shown, the substrate 500 comprises a non-aluminum substrate 506, a continuous aluminum layer 504 formed over the non-aluminum substrate 506, and an anodized layer 502 formed over the continuous aluminum layer 504. Depending on the example, the non-aluminum substrate may include a non-aluminum metal, such as magnesium, lithium, zinc, titanium, or niobium, or may include a non-aluminum alloy. Though FIG. 5 illustrates the structure of the substrate 500 as including elements (e.g., layers, coatings, etc.) that are disposed on and in contact with one another, for some examples, a set of other elements (e.g., layers, coating, etc.) may be present between two elements of the substrate 500.

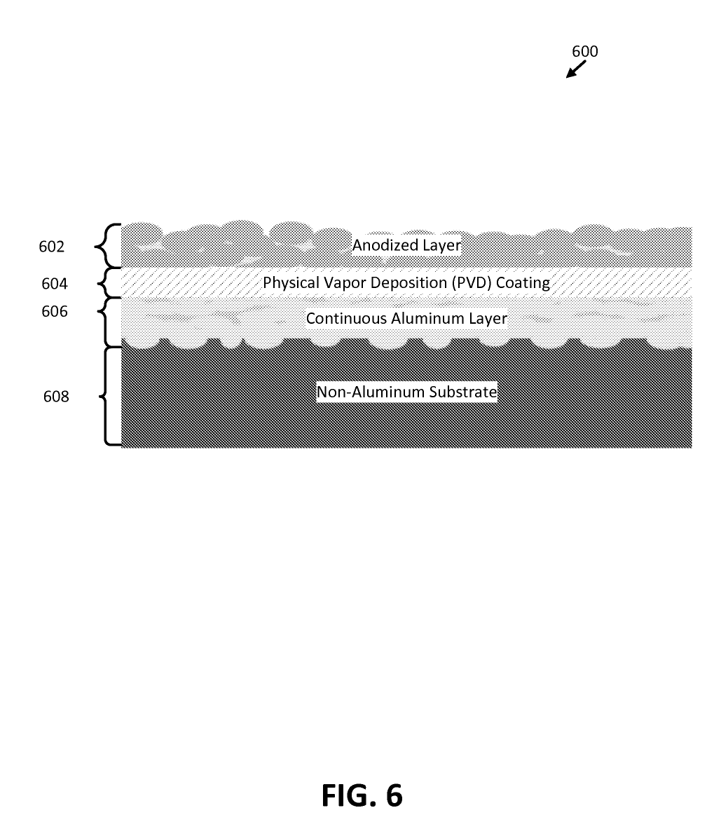

FIG. 6 illustrates an example substrate 600 according to the present disclosure. As shown, the substrate 600 comprises a non-aluminum substrate 608, a continuous aluminum layer 606 formed over the non-aluminum substrate 608, a physical vapor deposition (PVD) coating 604 formed over the continuous aluminum layer 606, and an anodized layer 602 formed over the PVD coating 604. As described herein, the non-aluminum substrate may include a non-aluminum metal, such as magnesium, lithium, zinc, titanium, or niobium, or may include a non-aluminum alloy. Though FIG. 6 illustrates the structure of the substrate 600 as including elements (e.g., layers, coatings, etc.) that are disposed on and in contact with one another, for some examples, a set of other elements (e.g., layers, coating, etc.) may be present between two elements of the substrate 600.

In the foregoing description, numerous details are set forth to provide an understanding of the subject disclosed herein. However, various examples may be practiced without some or all of these details. Some examples may include modifications and variations from the details discussed above. It is intended that the appended claims cover such modifications and variations.

1. A method, comprising:
disposing an aluminum powder coating over a non-metal substrate;
applying a laser to the aluminum powder coating to form a continuous aluminum layer over the non-metal substrate; and
forming an anodized layer over the continuous aluminum layer.

2. The method of claim 1, wherein the non-metal substrate comprises an organic resin and applying the laser to the aluminum powder coating causes removal of the organic resin.

3. The method of claim 1, wherein forming the anodized layer over the continuous aluminum layer comprises anodizing the continuous aluminum layer to form the anodized layer over the continuous aluminum layer.

4. The method of claim 1, comprising disposing a physical vapor deposition (PVD) coating over the continuous aluminum layer before forming the anodized layer over the continuous aluminum layer, wherein the PVD coating is interposed between the continuous aluminum layer and the anodized layer.

5. The method of claim 4, wherein forming the anodized layer over the continuous aluminum layer comprises anodizing the PVD coating to form the anodized layer over the continuous aluminum layer and the PVD coating.

6. A method, comprising:
disposing a plastic film over a non-metal substrate, wherein the plastic film comprises aluminum filler;
applying a laser to the plastic film to form a continuous aluminum layer over the non-metal substrate; and
forming an anodized layer over the continuous aluminum layer.

7. The method of claim 6, wherein disposing the plastic film over the non-metal substrate comprises insert molding the plastic film over the non-metal substrate.

8. The method of claim 6, wherein the non-metal substrate comprises an organic resin and applying the laser to the plastic film causes removal of the organic resin.

9. The method of claim 6, wherein forming the anodized layer over the continuous aluminum layer comprises anodizing the continuous aluminum layer to form the anodized layer over the continuous aluminum layer.

10. The method of claim 6, comprising disposing a physical vapor deposition (PVD) coating over the continuous aluminum layer before forming the anodized layer over the continuous aluminum layer, wherein the PVD coating is interposed between the continuous aluminum layer and the anodized layer.

11. The method of claim 10, wherein forming the anodized layer over the continuous aluminum layer comprises anodizing the PVD coating to form the anodized layer.

12. A substrate, comprising.
a non-aluminum substrate;
a continuous aluminum layer formed over tine non-aluminum substrate; and
an anodized layer over the continuous aluminum layer.

13. The substrate of claim 12, comprising a physical vapor deposition (PVD) coating interposed between the continuous aluminum layer and the anodized layer.

14. The substrate of claim 12, wherein the non-aluminum substrate comprises a metal selected from a group consisting of magnesium, lithium, zinc, titanium, and niobium.

15. The substrate of claim 12, wherein the non-aluminum substrate comprises polymer, a ceramic, or a composite.
